(19) United States
(12) Patent Application Publication
(10) Pub. No.: US 2014/0105247 A1
(43) Pub. Date: Apr. 17, 2014

(54) TEMPERATURE MEASUREMENT SYSTEM FOR HARD DISK DRIVE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: KANG WU, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/685,710

(22) Filed: Nov. 27, 2012

(30) Foreign Application Priority Data
Oct. 11, 2012 (CN) 201210382907X

(51) Int. Cl. G01K 7/01

(52) U.S. Cl. CPC G01K 7/01
USPC 374/178

(57) ABSTRACT

A temperature measurement system for a hard disk drive (HDD) includes a bipolar junction transistor (BJT) set inside the HDD, a temperature sensor, and a baseboard management controller (BMC) connected to the temperature sensor. A base of the BJT is connected to a collector of the BJT. The collector of the BJT is further connected to a first idle pin of a connector of the HDD. An emitter of the BJT is connected to a second idle pin of the connector of the HDD. The temperature sensor is connected to the first and second idle pins of the connector. The temperature sensor senses a voltage difference between the collector and the emitter of the BJT to obtain the temperature of the HDD. The BMC receives the temperature obtained through the temperature sensor.

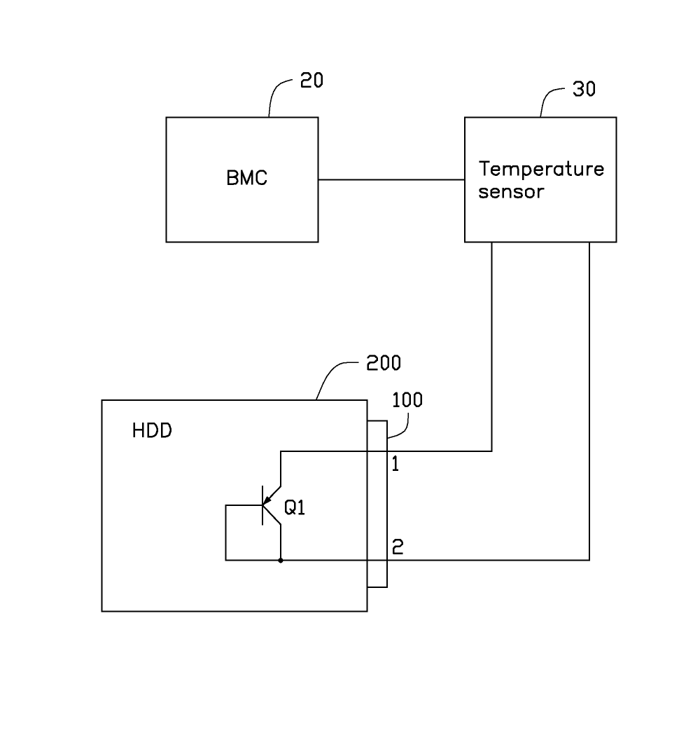

### BACKGROUND

1. Technical Field

The present disclosure relates to a system to measure a temperature of a hard disk drive (HDD).

2. Description of Related Art

It is important to monitor temperatures of HDDs in servers. Nowadays, the temperature of the HDD is obtained through a central processing unit (CPU). However, if the CPU is performing too many tasks it may not be able to monitor the HDD temperatures efficiently.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments. Moreover, in the drawing, like reference numerals designate corresponding parts throughout the view.

The FIGURE is a circuit diagram of an exemplary embodiment of a temperature measurement system.

### DETAILED DESCRIPTION

The disclosure, including the accompanying drawing, is illustrated by way of examples and not by way of limitation. It should be noted that references to “an” or “one” embodiment in this disclosure are not necessarily to the same embodiment, and such references mean at least one.

The FIGURE shows an embodiment of a temperature measurement system for a hard disk drive (HDD) 200. The temperature measurement system includes a bipolar junction transistor (BJT) Q1, a temperature sensor 30, and a baseboard management controller (BMC) 20.

In the embodiment, the HDD 200 is a 3.5 inch serial advanced technology attachment (SATA) HDD. According to SATA specifications, a SATA connector 100 of the HDD 200 includes signal pins and fifteen power pins. The first to third power pins of the SATA connector 100 are for connecting to a 3.3 volt power supply, the fourth to sixth power pins and the tenth and twelfth power pins are grounded, and the seventh to ninth power pins are for connecting to a 5 volt power supply, the eleventh power pin is a reserve pin, and the thirteenth to fifteenth power pins are for connecting to a 12 volt power supply. According to specifications for 3.5 inch SATA HDDs, the 3.3 volt power supply is not reserved so the first to third power pins are idle. As a result, in the embodiment, the first power pin and the second power pin of the SATA connector 100 are used to obtain the temperature of the HDD 200. In other embodiments, any two of the first to third power pins and the eleventh power pin of the SATA connector 100 can be used to obtain the temperature of the HDD 200.

The BJT Q1 is set inside the HDD 200. A base of the BJT Q1 is connected to a collector of the BJT Q1. The collector of the BJT Q1 is further connected to the second power pin of the connector 100 of the HDD 200. An emitter of the BJT Q1 is connected to the first power pin of the connector 100. The first and second power pins of the connector 100 are further connected to the temperature sensor 30. The temperature sensor 30 is further connected to the BMC 20 through inter-integrated circuit (I2C) bus.

When the temperature of the BJT Q1 varies, a voltage difference between the collector and the emitter of the BJT Q1 changes. As a result, when the temperature of the HDD 200 varies, the voltage difference between the collector and the emitter of the BJT Q1 changes. The temperature sensor 30 obtains the temperature of the HDD 200 according to the received voltage difference, and then transmits the temperature of the HDD 200 to the BMC 20 through the I2C bus.

Because the BMC 20 is not influenced by a central processing unit (CPU), and the CPU is not influenced by the BMC 20, the temperature measurement system can obtain the temperature of the HDD 200 without the CPU.

The foregoing description of the exemplary embodiments of the disclosure has been presented only for the purposes of illustration and description and is not intended to be exhaustive or to limit the disclosure to the precise forms disclosed. Many modifications and variations are possible in light of disclosure above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A temperature measurement system for a hard disk drive (HDD), the temperature measurement system comprising:
a bipolar junction transistor (BJT) set inside the HDD, wherein a base of the BJT is connected to a collector of the BJT, the collector of the BJT is further connected to a first idle pin of a connector of the HDD, and an emitter of the BJT is connected to a second idle pin of the connector of the HDD;
a temperature sensor connected to the first and second idle pins of the connector, wherein the temperature sensor senses a voltage difference between the collector and the emitter of the BJT to obtain the temperature of the HDD; and
a baseboard management controller (BMC) connected to the temperature sensor for receiving the temperature obtained through the temperature sensor.

2. The temperature measurement system of claim 1, wherein the BMC is connected to the temperature sensor through inter-integrated circuit bus.
